(19) United States
(12) Patent Application Publication
(10) Pub. No.: US 2019/0349118 A1
(43) Pub. Date: Nov. 14, 2019

(54) RAN-ASSISTED RATE ADAPTATION UNDER MOBILITY

(71) Applicants: Henry CHANG, San Diego, CA (US); Masato FUJISHIRO, San Diego, CA (US); Kyocera Corporation, Kyoto (JP)

(72) Inventors: Henry CHANG, San Diego, CA (US); Masato FUJISHIRO, Yokohama (JP)

(21) Appl. No.: 16/335,188

(22) PCT Filed: Sep. 28, 2017
(86) PCT No.: PCT/US2017/054109

§ 371 Date: Mar. 20, 2019

Related U.S. Application Data
(60) Provisional application No. 62/402,594, filed on Sep. 30, 2016.

(51) Int. Cl. H04L 1/00; H04L 1/20; H04W 24/10; H04W 28/22; H04W 80/12

(52) U.S. Cl. CPC H04L 1/0014; H04L 1/203; H04W 80/12; H04W 28/22; H04W 24/10

(57) ABSTRACT

Upon the occurrence of a change in radio condition, a base station transmits a rate recommendation to a first user equipment (UE) device. The rate recommendation is to be used for a Voice over Long-Term Evolution (VoLTE) call between the first UE device and a second UE device. In some instances, the first UE device and the second UE device negotiate the rate to be used for the VoLTE call, based on the rate recommended by the base station. The first and second UE devices implement a rate for the VoLTE call and provide feedback to a base station.

### CLAIM OF PRIORITY

The present application claims priority to Provisional Application No. 62/402,594, entitled “RAN-ASSISTED CODEC RATE ADAPTATION UNDER MOBILITY”, filed Sep. 30, 2016, assigned to the assignee hereof and hereby expressly incorporated by reference in its entirety.

### FIELD

This invention generally relates to wireless communications and more particularly to rate adaptation in a radio access network.

### BACKGROUND

3rd Generation Partnership Project (3GPP) specified a new voice codec named EVS (Enhanced Voice Services). A codec is a device or program that (1) encodes data for transmission and/or storage, and (2) decodes received data for playback, storage, and/or editing. EVS provides high voice quality over a wide range of rates, which allows the low EVS codec rates to still have sufficient quality, and may be used in poor coverage environments and overload scenarios. However, it is still desirable to use the higher codec rates for enhanced audio quality whenever possible. EVS has the flexibility, with a wider rate range and full audio bandwidth, to deliver speech quality that matches other audio inputs, such as stored music, while offering high robustness to delay, jitter, and packet losses.

Radio conditions may also impact the codec mode and codec rate. For example, under poor radio conditions, a lower codec rate may be used to reduce the packet loss, whereas a higher codec rate can be used in good radio conditions to ensure a better user experience. Therefore, a flexible and efficient codec modification mechanism is needed that accounts for the voice codec, network capacity, radio conditions, and user experience.

### SUMMARY

Upon the occurrence of a change in radio condition, a base station transmits a rate recommendation to a first user equipment (UE) device. The rate recommendation is to be used for a Voice over Long-Term Evolution (VoLTE) call between the first UE device and a second UE device. In some instances, the first UE device and the second UE device negotiate the rate to be used for the VoLTE call, based on the rate recommended by the base station. The first and second UE devices implement a rate for the VoLTE call and provide feedback to a base station.

### BRIEF DESCRIPTION OF THE DRAWINGS

FIG. 1 is a block diagram of a communication system for an example in which a first user equipment (UE) device receives a rate recommendation to be used for a Voice over Long-Term Evolution (VoLTE) call with a second UE device.

FIG. 2A is a block diagram of an example of the base stations shown in FIG.

FIG. 2B is a block diagram of an example of the UE devices shown in FIG. 1.

FIG. 3 is a messaging diagram of an example in which a rate adaptation process is initiated upon the occurrence of a change in radio condition.

FIG. 4 is a messaging diagram of an example in which a source base station is handing over the first UE device to a target base station.

FIG. 5 is a flowchart of an example of a method in which in which a rate adaptation process is initiated upon the occurrence of a change in radio condition.

FIG. 6 is a flowchart of an example of a method in which a source base station is handing over the first UE device to a target base station.

### DETAILED DESCRIPTION

Voice-over-LTE (VoLTE) is a key feature for the 3GPP Long Term Evolution (LTE) communication specification to provide voice service and is being deployed and launched by operators all over the world, which makes VoLTE capability extremely important for operators. One of the critical factors that may impact the user experience of VoLTE service is the voice codec configuration. For example, a higher Adaptive Multi-Rate (AMR) voice code rate may provide a higher-definition voice call and accordingly a better user experience. When a higher AMR voice code rate is used, the higher codec rate requires more radio resource allocation, which implies less available network capacity.

The base station (e.g., eNB) of the Radio Access Network (RAN) is in the best position to trigger voice codec rate adaptation. Thus, an eNB-assisted (or RAN-assisted) codec rate adaptation solution should be considered. In order to support eNB-assisted codec rate adaptation, one of the main questions to consider is if the eNB needs to have the information on the specific codec rates for each type of supported codec. If we assume the eNB has specific information about the codec rates, we should also consider if the eNB would also need to know the codec type, the frame aggregation, the redundancy level, and the redundancy offset. This would imply the eNB could essentially serve as the end point for codec rate adaptation in place of the user equipment (UE) device.

However, if the eNB only has the codec rate information, it is unclear how much weight the UE device should give to the eNB's recommended codec rate as one of the inputs to the UE device's application layer. Note that traditionally eNBs do not handle any application layer signaling. Rather, they only handle the Access Stratum (AS) part of the LTE system. Adding application layer signaling within the eNB would drastically change the existing paradigm of how the network architecture is structured.

Moreover, as the UE device moves in and out of coverage, the eNB's selection of a recommended rate for the UE device should be a function of the UE device's radio condition and whether the recommended rate is applicable to the UE device when the UE device is handed over to a target eNB.

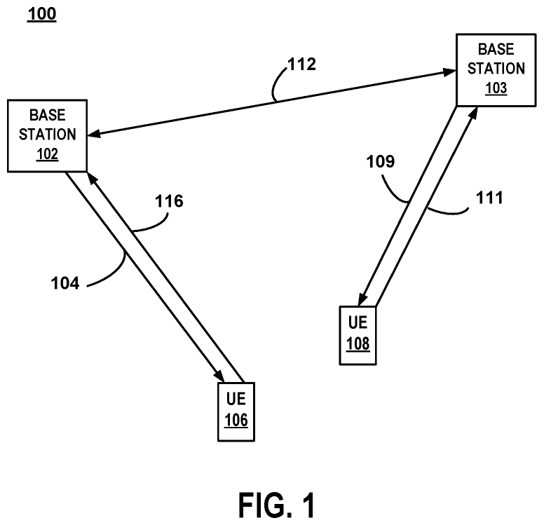

FIG. 1 is a block diagram of a communication system for an example in which a first user equipment (UE) device receives a rate recommendation to be used for a Voice over Long-Term Evolution (VoLTE) call with a second UE device. The communication system 100 is part of a radio access network (not shown) that provides various wireless services to UE devices that are located within the respective service areas of the various base stations that are part of the radio access network. The base station 102 provides wireless services to UE device 106 via downlink signals 104.

In the interest of clarity and brevity, communication system 100 is shown as having only two base stations 102, 103. Initially, first base station 102 provides wireless services to UE device 106, and second base station 103 provides wireless services to UE device 108. However, in other examples, communication system 100 could have any suitable number of base stations. Base stations 102, 103, which are sometimes referred to as an eNodeB or eNB, communicate with the wireless user equipment (UE) devices 106, 108 by transmitting downlink signals 104, 109 to the UE devices 106, 108, respectively. Base stations 102, 103 receive uplink signals 116, 111 transmitted from the UE devices 106, 108, respectively. The UE devices 106, 108 are any wireless communication devices such as mobile phones, transceiver modems, personal digital assistants (PDAs), and tablets, for example.

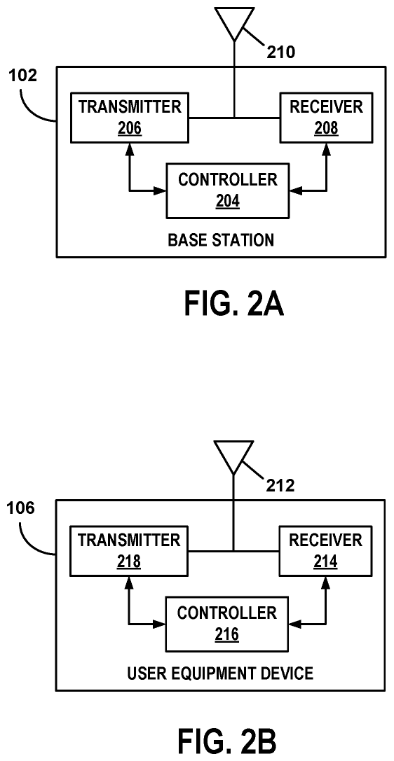

Base stations 102, 103 are connected to the network through a backhaul (not shown) in accordance with known techniques. As shown in FIG. 2A, base station 102 comprises controller 204, transmitter 206, and receiver 208, as well as other electronics, hardware, and code. Although FIG. 2A specifically depicts the circuitry and configuration of first base station 102, the same base station circuitry and configuration is utilized for second base station 103. The base station 102 is any fixed, mobile, or portable equipment that performs the functions described herein. The various functions and operations of the blocks described with reference to the base station 102 may be implemented in any number of devices, circuits, or elements. Two or more of the functional blocks may be integrated in a single device, and the functions described as performed in any single device may be implemented over several devices.

For the example shown in FIG. 2A, the base station 102 may be a fixed device or apparatus that is installed at a particular location at the time of system deployment. Examples of such equipment include fixed base stations or fixed transceiver stations. In some situations, the base station 102 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 102 may be a portable device that is not fixed to any particular location. Accordingly, the base station 102 may be a portable user device such as a UE device in some circumstances.

The controller 204 includes any combination of hardware, software, and/or firmware for executing the functions described herein as well as facilitating the overall functionality of the base station 102. An example of a suitable controller 204 includes code running on a microprocessor or processor arrangement connected to memory. The transmitter 206 includes electronics configured to transmit wireless signals. In some situations, the transmitter 206 may include multiple transmitters. The receiver 208 includes electronics configured to receive wireless signals. In some situations, the receiver 208 may include multiple receivers. The receiver 208 and transmitter 206 receive and transmit signals, respectively, through an antenna 210. The antenna 210 may include separate transmit and receive antennas. In some circumstances, the antenna 210 may include multiple transmit and receive antennas.

The transmitter 206 and receiver 208 in the example of FIG. 2A perform radio frequency (RF) processing including modulation and demodulation. The receiver 208, therefore, may include components such as low noise amplifiers (LNAs) and filters. The transmitter 206 may include filters and amplifiers. Other components may include isolators, matching circuits, and other RF components. These components in combination or cooperation with other components perform the base station functions. The required components may depend on the particular functionality required by the base station.

The transmitter 206 includes a modulator (not shown), and the receiver 208 includes a demodulator (not shown). The modulator modulates the signals to be transmitted as part of the downlink signals 104 and can apply any one of a plurality of modulation orders. The demodulator demodulates any signals, including uplink signals 116, received at the base station 102 in accordance with one of a plurality of modulation orders.

Returning to FIG. 1, the communication system 100 provides various wireless services to the UE devices 106, 108 via base stations 102, 103, respectively. For the examples herein, the communication system 100 operates in accordance with at least one revision of the 3rd Generation Partnership Project Long Term Evolution (3GPP LTE) communication specification. A first UE device 106 receives downlink signal 104 via antenna 212 and receiver 214, as shown in FIG. 2B. Although FIG. 2B specifically depicts the circuitry and configuration of first UE device 106, the same UE device circuitry and configuration is utilized for second UE device 108. Besides antenna 212 and receiver 214, the first UE device 106 further comprises controller 216 and transmitter 218, as well as other electronics, hardware, and code. The first UE device 106 is any fixed, mobile, or portable equipment that performs the functions described herein. The various functions and operations of the blocks described with reference to the first UE device 106 may be implemented in any number of devices, circuits, or elements. Two or more of the functional blocks may be integrated in a single device, and the functions described as performed in any single device may be implemented over several devices.

The controller 216 includes any combination of hardware, software, and/or firmware for executing the functions described herein as well as facilitating the overall functionality of a UE device. An example of a suitable controller 216 includes code running on a microprocessor or processor arrangement connected to memory. The transmitter 218 includes electronics configured to transmit wireless signals. In some situations, the transmitter 218 may include multiple transmitters. The receiver 214 includes electronics configured to receive wireless signals. In some situations, the receiver 214 may include multiple receivers. The receiver 214 and transmitter 218 receive and transmit signals, respectively, through antenna 212. The antenna 212 may include separate transmit and receive antennas. In some circumstances, the antenna 212 may include multiple transmit and receive antennas.

The transmitter 218 and receiver 214 in the example of FIG. 2B perform radio frequency (RF) processing including modulation and demodulation. The receiver 214, therefore, may include components such as low noise amplifiers (LNAs) and filters. The transmitter 218 may include filters and amplifiers. Other components may include isolators, matching circuits, and other RF components. These components in combination or cooperation with other components perform the UE device functions. The required components may depend on the particular functionality required by the UE device.

The transmitter 218 includes a modulator (not shown), and the receiver 214 includes a demodulator (not shown). The modulator can apply any one of a plurality of modulation orders to modulate the signals to be transmitted as part of the uplink signals 116, which are shown in FIG. 1. The demodulator demodulates the downlink signals 104 in accordance with one of a plurality of modulation orders.

For the purposes of the examples described herein, it is assumed that base stations 102, 103 are agnostic to codec rate information. Thus, the base station 102 is not aware of which bit rates match with the codec rates available to the UE devices 106, 108 in the application layer. Therefore, the base station 102 must be informed regarding which bit rates are appropriate to recommend to the UE device 106; for purposes of rate adaptation, this is an important detail since the UE device 106 cannot autonomously decide which bit rate to use without permission from the base station 102.

In operation, the rate adaptation process is initiated due to changes in one or more radio conditions. For example, the change in radio condition that triggers the rate adaptation process may be a change in the radio condition of the first UE device 106, a change in the radio condition of the second UE device 108, a change in the radio condition of the first base station 102, a change in the radio condition of the second base station 103, or some combination thereof. In the instances in which the change in radio condition is a change in the radio condition of the first UE device 106, the base station 102 needs to know the radio condition of the UE device 106 in order to determine a rate to recommend to the UE device 106.

There are several different options for determining the occurrence of a triggering event that would cause the UE device 106 to report its radio condition to the base station 102 so the base station 102 can determine which rate to recommend to the UE device 106. The first option utilizes existing mechanisms for radio condition reporting by the UE device 106. For this option, the base station 102 configures the UE device 106 to periodically report its radio condition to the base station 102. However, periodic reporting would lower the resource efficiency of the Radio Access Network (RAN).

The second option defines new event triggers for codec rate adaptation. For example, one or more different event triggers would be configured for each of the different available codec rates. Stated differently, the triggering events may correspond to events/conditions that may indicate that a codec rate change may be advisable. Thus, when a triggering event occurs, the UE device 106 reports its radio condition to the base station 102 in order to initiate a rate adaptation process. However, such an extensive event trigger mechanism may not be needed solely to implement codec rate adaptation.

In the third option, the base station 102 broadcasts a list of bit rates that correspond to a list of radio conditions. For example, the broadcast may include a mapping relationship based on which codec rates (or bit rates) are associated with which radio conditions. Thus, the UE device 106 would report its radio condition to the base station 102 when its radio condition changed sufficiently to correspond with a different bit rate, according to the rate-to-radio condition mapping previously broadcast by the base station 102. However, since the radio condition of the second UE device 108 must be taken into account when selecting which rate to use for the VoLTE call between the first UE device 106 and the second UE device 108, the final rate requested by the first UE device 106 will be based on the rate that corresponds with the worse of the respective radio conditions of the first and second UE devices 106, 108. Moreover, the base station 102 cannot configure the recommended rate per UE device. Thus, any changes to the mappings must be updated at System Information boundaries.

In the fourth option, the UE device 106 requests a rate increase or decrease when the radio condition of the UE device 106 changes by a pre-determined threshold value. For example, the base station 102 configures a pre-determined threshold value indicating when the UE device 106 should report its radio condition to the base station 102. The base station 102 conveys the pre-determined threshold value to the UE device 106 via dedicated signaling or a System Information transmission.

If the radio condition changes by the pre-determined threshold value relative to a reference level, then the UE device 106 reports its radio condition to the base station 102. In some examples, the radio condition is a Reference Signals Received Power (RSRP) level measured by the UE device 106, and the reference RSRP level is the RSRP level measured when either (1) the UE device 106 last received the recommended bit rate, or (2) the UE device 106 last reported its radio condition to the base station 102. Thus, the UE device 106 would need to be configured to store the reference RSRP level in order to compare the measured RSRP level to the currently stored reference RSRP level.

In other examples of the fourth option, the UE device 106 has the option to perform a rate negotiation (e.g., via Application Layer signaling) with the second UE device 108 prior to reporting the radio condition of the UE device 106 to the base station 102. If the radio condition of the second UE device 108 degrades, the first UE device 106 may refrain from reporting the radio condition of the first UE device 106 to the base station 102.

In the fifth option, the UE device 106 reports its radio condition to the base station 102 when the target Block Error Rate (BLER) increases above or decreases below a target BLER level by a threshold amount. In this example, the UE device 106 uses the target BLER for each of the Enhanced Voice Services (EVS) codec rates. If the BLER increases above or decreases below a target BLER level by a threshold amount, the UE device 106 reports the measured BLER, along with the radio condition of the UE device 106, to the base station 102. In some examples, if the BLER decreases below the target BLER level by the threshold amount, the UE device 106 has the option to refrain from reporting the measured BLER and the radio condition of the UE device 106 to the base station 102, if the second UE device 108 has a radio condition that is not favorable to requesting a higher rate from the base station 102.

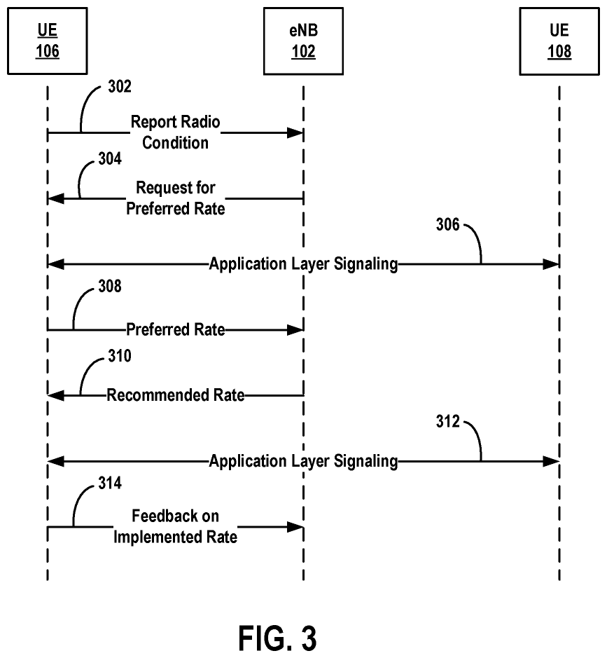

Regardless of the option used for determining the occurrence of a triggering event that would cause the UE device 106 to report its radio condition to the base station 102, the UE device 106 transmits its radio condition to base station 102, using transmitter 218 and antenna 212. The radio condition report is represented in FIG. 3 by signal 302. Base station 102 receives the radio condition report via antenna 210 and receiver 208. After receiving the radio condition report from the UE device 106, the base station 102 transmits, via transmitter 206 and antenna 210, a request for a preferred rate to the UE device 106. The UE device 106 receives the request for a preferred rate using antenna 212 and receiver 214. The request for a preferred rate is represented in FIG. 3 by signal 304.

In response to the request for a preferred rate, the first UE device 106 has the option of negotiating with the second UE device 108 to determine a rate to be used for the VoLTE call between the first and second UE devices 106, 108. The first UE device 106 and the second UE device 108 use their respective transmitters 218, controllers 216, and antennas 212 to negotiate the rate via the application layer. This rate negotiation occurs via communication link 112 in FIG. 1 and is represented in FIG. 3 by Application Layer Signaling 306. In other examples, the first UE device 106 may already know which rate the second UE device 108 is capable of using for the VoLTE call, and thus, no negotiation is required. In still other examples, the first UE device 106 may simply elect to submit a preferred rate to the base station 102 without negotiating the rate beforehand with the second UE device 108.

Regardless of whether the first and second UE devices 106, 108 negotiate a rate to be used for the VoLTE call, the first UE device 106 transmits a preferred rate to base station 102, using transmitter 218 and antenna 212. The preferred rate is represented in FIG. 3 by signal 308. Base station 102 receives the preferred rate via antenna 210 and receiver 208.

After receiving the preferred rate from the UE device 106, the base station 102 utilizes controller 204 to determine a rate to recommend to the UE device 106. The recommended rate takes into account, among other factors, the reported radio condition of the first UE device 106, the preferred rate transmitted by the first UE device 106, and the current level of network congestion measured by the base station 102. Of course, any other suitable criteria may be used by the base station 102 in selecting a recommended rate. In some cases, the recommended rate is a bit rate supported by the base station 102. The rate recommendation, in some examples, is a recommendation for a higher rate. In other examples, the rate recommendation is a recommendation for a lower rate. After determining which rate to recommend to the UE device 106, the base station 102 transmits, via transmitter 206 and antenna 210, the recommended rate to the UE device 106. The recommended rate is represented in FIG. 3 by signal 310.

The UE device 106 receives the recommended rate using antenna 212 and receiver 214. Upon receipt of the rate recommendation, the controller 216 of first UE device 106 determines whether to (1) implement (e.g., accept) the recommended rate, (2) reject the recommended rate, (3) request a different rate than the recommended rate, (4) negotiate the rate with second UE device 108, or (5) perform any combination of two or more of the foregoing options. If the UE device 106 chooses to initiate a rate negotiation with the second UE device 108 to determine a rate to be used for the VoLTE call between the first and second UE devices 106, 108, this rate negotiation is represented in FIG. 3 by Application Layer Signaling 312. In other examples, the first UE device 106 may already know which rate the second UE device 108 is capable of using for the VoLTE call, and thus, this rate negotiation is not required.

Once the rate negotiation between the first and second UE devices 106, 108 concludes, or is skipped, the first and second UE devices 106, 108 implement a rate for the VoLTE call. After implementing the rate, the first UE device 106 transmits, using transmitter 218 and antenna 212, a feedback signal to the base station 102, indicating which rate was implemented for the VoLTE call between the first and second UE devices 106, 108. Base station 102 receives the feedback signal via antenna 210 and receiver 208. The feedback signal is represented in FIG. 3 by signal 314.

FIG. 3 is a messaging diagram of an example in which a rate adaptation process is initiated upon the occurrence of a change in radio condition. In this example, the first UE device 106 transmits its radio condition to base station 102, via signal 302, as an uplink signal 116 to base station 102. Base station 102 transmits a request for a preferred rate to the UE device 106 via signal 304.

First UE device 106 has the option of negotiating a rate to be used for a VoLTE call between the first and second UE devices 106, 108. If first UE device 106 chooses to initiate this negotiation, the negotiation is conducted via Application Layer Signaling between first UE device 106 and second UE device 108, which is represented by signal 306. After conducting, or skipping, the rate negotiation, the first UE device 106 transmits a preferred rate to base station 102. The preferred rate is represented in FIG. 3 by signal 308. After receiving the preferred rate from the UE device 106, the base station 102 determines a rate to recommend to the UE device 106. The base station 102 transmits, via signal 310, the recommended rate to the UE device 106.

Upon receipt of the rate recommendation, the first UE device 106 determines whether to negotiate the rate with second UE device 108. If the UE device 106 chooses to initiate a rate negotiation with the second UE device 108 to determine a rate to be used for the VoLTE call between the first and second UE devices 106, 108, this rate negotiation is represented in FIG. 3 by Application Layer Signaling 312. In other examples, the first UE device 106 may already know which rate the second UE device 108 is capable of using for the VoLTE call, and thus, this rate negotiation is not required.

Once the rate negotiation between the first and second UE devices 106, 108 concludes, or is skipped, the first and second UE devices 106, 108 implement a rate for the VoLTE call. After implementing the rate, the first UE device 106 transmits a feedback signal to the base station 102, indicating which rate was implemented for the VoLTE call between the first and second UE devices 106, 108. The feedback signal is represented in FIG. 3 by signal 314.

Several different options were discussed above for determining the occurrence of a triggering event that would cause the UE device 106 to report its radio condition to the base station 102 so the base station 102 can determine which rate to recommend to the UE device 106. In other examples, the change in radio condition that triggers the UE device 106 to report its radio condition occurs when the radio condition of the first UE device 106 exceeds a pre-determined handover threshold. In these examples, upon receipt of the radio condition report, the base station 102 initiates the rate adaptation process and a handover procedure, as described below.

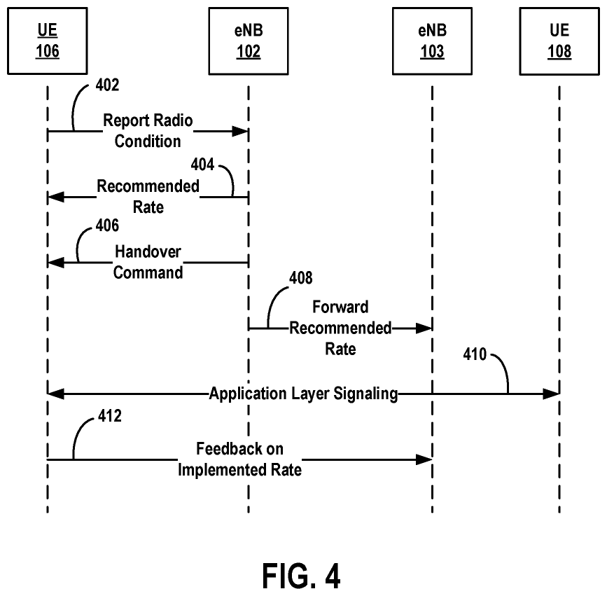

For example, the UE device 106 transmits its radio condition to source base station 102, using transmitter 218 and antenna 212, when the radio condition of the UE device 106 exceeds a pre-determined handover threshold. The radio condition report is represented in FIG. 4 by signal 402. Source base station 102 receives the radio condition report via antenna 210 and receiver 208.

After receiving the radio condition report from the UE device 106, the source base station 102 utilizes controller 204 to determine a rate to recommend to the UE device 106. The recommended rate takes into account, among other factors, the reported radio condition of the first UE device 106 and the current level of network congestion measured by the base station 102. Of course, any other suitable criteria may be used by the base station 102 in selecting a recommended rate. In some cases, the recommended rate is a bit rate supported by the base station 102. The rate recommendation, in some examples, is a recommendation for a higher rate. In other examples, the rate recommendation is a recommendation for a lower rate. After determining which rate to recommend to the UE device 106, the source base station 102 transmits, via transmitter 206 and antenna 210, the recommended rate to the UE device 106. The UE device 106 receives the recommended rate using antenna 212 and receiver 214. The recommended rate is represented in FIG. 4 by signal 404.

The source base station 102 transmits, via transmitter 206 and antenna 210, a handover command to the UE device 106, which instructs the UE device 106 to handover to target base station 103. The handover command is represented in FIG. 4 by signal 406. The source base station 102 also forwards, via transmitter 206 and antenna 210, the recommended rate to the target base station 103 as part of the UE context, which is represented in FIG. 4 by signal 408.

After receiving the recommended rate and the handover command, the first UE device 106 has the option of negotiating with the second UE device 108 to determine a rate to be used for the VoLTE call between the first and second UE devices 106, 108. The first UE device 106 and the second UE device 108 use their respective transmitters 218, controllers 216, and antennas 212 to negotiate the rate via the application layer. This rate negotiation is represented in FIG. 4 by Application Layer Signaling 410. In other examples, the first UE device 106 may already know which rate the second UE device 108 is capable of using for the VoLTE call, and thus, no negotiation is required.

Once the rate negotiation between the first and second UE devices 106, 108 concludes, or is skipped, the first and second UE devices 106, 108 implement a rate for the VoLTE call. After implementing the rate, the first UE device 106 transmits a feedback signal to the target base station 103, indicating which rate was implemented for the VoLTE call between the first and second UE devices 106, 108. The feedback signal is represented in FIG. 4 by signal 412.

FIG. 4 is a messaging diagram of an example in which a source base station 102 is handing over the first UE device 106 to a target base station 103. In this example, the first UE device 106 transmits its radio condition to source base station 102, via signal 402, as an uplink signal 116 to source base station 102. Source base station 102 transmits a recommended rate to the UE device 106 via signal 404.

The source base station 102 also transmits a handover command to the UE device 106, which instructs the UE device 106 to handover to target base station 103. The handover command is represented in FIG. 4 by signal 406. The source base station 102 also forwards the recommended rate to the target base station 103 as part of the UE context, which is represented in FIG. 4 by signal 408.

First UE device 106 has the option of negotiating a rate to be used for a VoLTE call between the first and second UE devices 106, 108. If first UE device 106 chooses to initiate this negotiation, the negotiation is conducted via Application Layer Signaling between first UE device 106 and second UE device 108, which is represented by signal 410. After conducting, or skipping, the rate negotiation, the first and second UE devices 106, 108 implement a rate for the VoLTE call. After implementing the rate, the first UE device 106 transmits a feedback signal to the target base station 103, indicating which rate was implemented for the VoLTE call between the first and second UE devices 106, 108. The feedback signal is represented in FIG. 4 by signal 412.

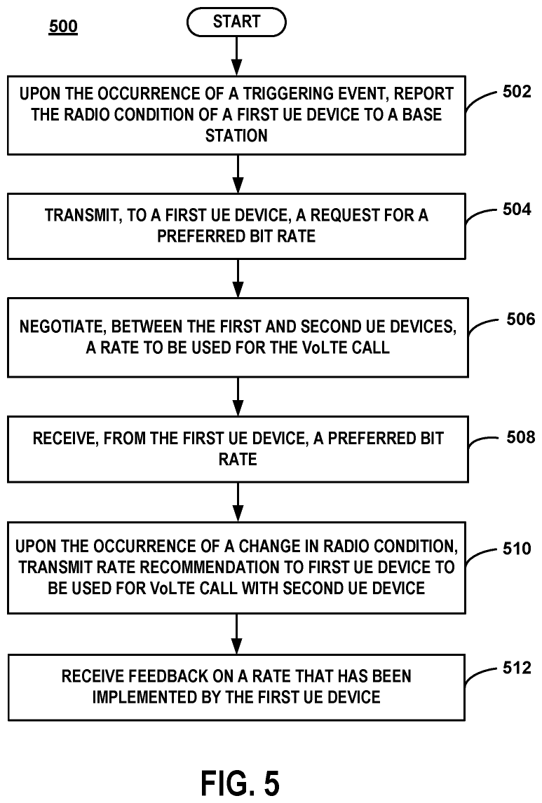

FIG. 5 is a flowchart of an example of a method in which a rate adaptation process is initiated upon the occurrence of a change in radio condition. The method 500 begins at step 502, in which UE device 106 reports its radio condition to a base station 102, upon the occurrence of a triggering event. At step 504, the base station 102 transmits a request for a preferred bit rate to the UE device 106. Upon receipt of the request for a preferred bit rate, the first UE device 106 has the option of negotiating, with a second UE device 108, a rate to be used for a VoLTE call between the first and second UE devices 106, 108, at step 506. After the rate negotiation at step 506 is concluded, or skipped, the first UE device 106 transmits a preferred bit rate to the base station 102, at step 508.

Upon the occurrence of a change in the radio condition of the first UE device 106, the base station 102 transmits, at step 510, a rate recommendation to first UE device 106 to be used for a VoLTE call with second UE device 108. At step 512, the first and second UE devices 106, 108 implement a rate for the VoLTE call. After implementing the rate, the first UE device 106 transmits a feedback signal to the base station 102, indicating which rate was implemented for the VoLTE call between the first and second UE devices 106, 108.

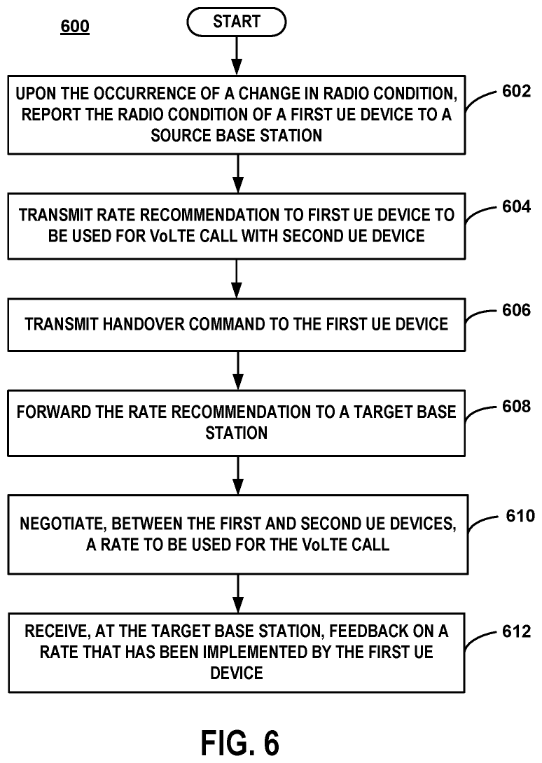

FIG. 6 is a flowchart of an example of a method in which a source base station is handing over the first UE device to a target base station. The method 600 begins at step 602, in which UE device 106 reports its radio condition to a source base station 102, upon the occurrence of a change in the radio condition of the UE device 106. At step 604, the source base station 102 transmits a rate recommendation to first UE device 106 to be used for a VoLTE call with second UE device 108. At step 606, the source base station 102 transmits a handover command instructing the first UE device 106 to handover to a target base station 103. At step 608, the source base station 102 also forwards the recommended rate to the target base station 103 as part of the UE context.

At step 610, the first UE device 106 has the option of negotiating, with a second UE device 108, a rate to be used for a VoLTE call between the first and second UE devices 106, 108. After the rate negotiation is concluded, or skipped, the first and second UE devices 106, 108 implement a rate for the VoLTE call. After implementing the rate, the first UE device 106 transmits, at step 612, a feedback signal to the target base station 103, indicating which rate was implemented for the VoLTE call between the first and second UE devices 106, 108.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A method comprising:
upon the occurrence of a change in radio condition, transmitting, from a base station, a rate recommendation to a first user equipment (UE) device, the rate recommendation to be used for a Voice over Long-Term Evolution (VoLTE) call with a second UE device; and
implementing the rate recommendation.

2. The method of claim 1, wherein the rate recommendation comprises a bit rate supported by the base station.

3. The method of claim 1, wherein the radio condition is a radio condition of the first UE device, the method further comprising:
upon the occurrence of a triggering event, reporting the radio condition of the first UE device to the base station.

4. The method of claim 3, wherein the triggering event comprises the radio condition changing by a threshold amount relative to a reference level.

5. The method of claim 4, wherein the radio condition comprises at least one of the following: a measured Reference Signals Received Power (RSRP) level, and a measured Block Error Rate (BLER) level, and
wherein the reference level comprises at least one of the following: a reference RSRP level, and a reference BLER level.

6. The method of claim 2, further comprising:
transmitting, to the first UE device, a request for a preferred bit rate.

7. The method of claim 6, further comprising:
receiving a preferred bit rate from the first UE device.

8. A system comprising:
a base station comprising a transmitter configured to transmit, upon the occurrence of a change in radio condition, a rate recommendation; and
a first user equipment (UE) device comprising:
a receiver configured to receive the rate recommendation, the rate recommendation to be used for a Voice over Long-Term Evolution (VoLTE) call between the first UE device and a second UE device, and
a controller configured to implement the rate recommendation.

9. The system of claim 8, wherein the rate recommendation comprises a bit rate supported by the base station.

10. The system of claim 8, wherein the radio condition is a radio condition of the first UE device.

11. The system of claim 10, wherein the first UE device further comprises:
a transmitter configured to transmit, upon the occurrence of a triggering event, the radio condition of the first UE device to the base station.

12. The system of claim 11, wherein the triggering event comprises the radio condition changing by a threshold amount relative to a reference level.

13. The system of claim 12, wherein the radio condition comprises at least one of the following: a measured Reference Signals Received Power (RSRP) level, and a measured Block Error Rate (BLER) level, and
wherein the reference level comprises at least one of the following: a reference RSRP level, and a reference BLER level.

14. The system of claim 9, wherein the transmitter of the base station is further configured to transmit, to the first UE device, a request for a preferred bit rate.

15. The system of claim 14, wherein the base station further comprises a receiver configured to receive a preferred bit rate from the first UE device.
